(19) United States
(12) Patent Application Publication
(10) Pub. No.: US 2014/0168928 A1
(43) Pub. Date: Jun. 19, 2014

(54) Pivoting Mechanism and Electronic Device Thereof

(71) Applicant: Chung-Yu Lee, New Taipei City (TW)

(72) Inventor: Chung-Yu Lee, New Taipei City (TW)

(21) Appl. No.: 13/714,574

(22) Filed: Dec. 14, 2012

(51) Int. Cl. F16C 11/04; H02B 1/015

(52) U.S. Cl. CPC F16C 11/045; H02B 1/015
USPC 361/809; 16/386

(57) ABSTRACT

A pivoting mechanism capable of being passed through by a wire is disclosed. The pivoting mechanism includes a first fixing portion and a second fixing portion. The first fixing portion includes a pivot body. An accommodating slot is formed on a surface of the pivot body, and the accommodating slot stretches from a side of the pivot body to the other side of the pivot body. The second fixing portion includes an annular body corresponding to the pivot body, and a pivot hole is formed around the annular body. The pivot body passes through the pivot hole. The first fixing portion pivots to the second pivoting portion via a combination of the pivot body and the annular body, and the wire passes through the accommodating slot. The present invention has low manufacturing cost and preferred assembly convenience.

### BACKGROUND OF THE INVENTION

1. Field of the Invention

The present invention relates to a pivoting mechanism and an electronic device thereof, and more particularly, to a pivoting mechanism having electrical connecting function and an electronic device thereof.

2. Description of the Prior Art

A conventional electronic device, such as the portable electronic device (the notebook computer), includes two boards capable of pivoting to each other. The first board can include the panel and the backlight module, and the second board can include the electronic units, the battery and the keyboard. The first board pivots to the second board via the pivot axle, so that the first board can be folded and unfolded relative to the second board.

A pivoting set is disclosed in US patent Publication No. 2009/0089975. The pivoting set includes the first fixing portion, the second fixing portion, and the pivot axle disposed between the fixing portions. The first fixing portion and the second fixing portion are respectively disposed on the first board and the second board, so that the first board can pivot relative to the second board via the pivoting set. However, the pivoting set can not transmit signals between the first board and the second board. Generally, the transmission cable is disposed by a side of the pivoting set. For example, the transmission cable is disposed adjacent to the first fixing portion, the pivot body and the second fixing portion in sequence, then the signals can be transmitted between the first board and the second board via the transmission cable. However, the transmission cable may be damaged by friction of the peripheral units, the pivoting set and the pivot body as the first board is folded and unfolded relative to the second board.

The other pivoting set is disclosed in US patent Publication No. 2011/0242756. The pivoting set includes the first fixing portion, the pivot body and the second fixing portion, which are the same as the former embodiment. The pivoting set further designs that the pivot body is the hollow structure, so the transmission cable passes through the hollow structure. Two ends of the transmission cable are respectively connected to the first board and the second board. Friction of the transmission cable is reduced, to prevent the transmission cable from damage. However, the manufacturing cost of the hollow structure of the pivot body is expensive. Besides, the transmission cable disposed inside the hollow structure may be rubbed by the inner wall of the pivot body, and the lubricant is utilized inside the pivot body to decrease friction.

Therefore, design of a pivoting mechanism and an electronic device thereof capable of forming the accommodating slot corresponding to the wire on the surface of the pivot body and improving the friction between the wire and the pivot mechanism for low cost is an important issue in the mechanical industry.

### SUMMARY OF THE INVENTION

The present invention provides a pivoting mechanism and an electronic device thereof to form the accommodating slot corresponding to the wire on the surface of the pivot body and to improve the friction between the wire and the pivot mechanism for low cost.

According to the claimed invention, a pivoting mechanism capable of being passed through by a wire is disclosed. The pivoting mechanism includes a first fixing portion and a second fixing portion. The first fixing portion includes a pivot body. An accommodating slot is formed on a surface of the pivot body, and the accommodating slot stretches from a side of the pivot body to the other side of the pivot body. The second fixing portion includes an annular body corresponding to the pivot body, and a pivot hole is formed around the annular body. The pivot body passes through the pivot hole, the first fixing portion pivots to the second pivoting portion via a combination of the pivot body and the annular body, and the wire passes through the accommodating slot.

According to the claimed invention, a plurality of accommodating slots is formed on the surface of the pivot body, the accommodating slots are arranged along an axial direction of the pivot body, the wire comprises a plurality of sub-wires, and the sub-wires are respectively disposed inside the corresponding accommodating slots.

According to the claimed invention, the accommodating slot is substantially parallel to an axial direction of the pivot body.

According to the claimed invention, the accommodating slot surrounds the surface of the pivot body in a spiral manner.

According to the claimed invention, a depth of the accommodating slot is substantially greater than a thickness of the wire.

According to the claimed invention, the pivoting mechanism further includes a jointing component corresponding to the wire. The wire is fixed inside the accommodating slot by the jointing component.

According to the claimed invention, the jointing component includes an adhesive layer disposed on a bottom of the accommodating slot. The wire is adhered inside the accommodating slot via the adhesive layer.

According to the claimed invention, the second fixing portion further includes a fixing side. The annular body includes a first annular wall and a second annular wall. The first annular wall stretches from the fixing side and surrounding the pivot hole along a counterclockwise direction, and a first opening is formed between an end of the first annular wall and the fixing side. The second annular wall stretches from the fixing side and surrounding the pivot hole along a clockwise direction, and a second opening is formed between an end of the second annular wall and the fixing side.

According to the claimed invention, an electronic device includes the pivoting mechanism, a cable, a first board and a second board. The cable includes the wire, a first connector and an second connector are respectively disposed on two ends of the cable. The first board is locked with the first fixing portion. The first board includes a first electronic unit electrically connected to the first connector. The second board is locked with the second fixing portion. The second board includes a second electronic unit electrically connected to the second connector. The first board pivots to the second board, the first electronic unit is electrically connected to the second electronic unit.

According to the claimed invention, the first fixing portion further includes a first fixing slab whereon a first fixing hole is formed, and the first fixing hole corresponds to a first fixing component. The second fixing portion further includes a second fixing slab whereon a second fixing hole is formed, and the second fixing hole corresponds to a second fixing component. The first fixing component passes through the first fixing hole to lock the first fixing slab and the first board. The second fixing component passes through the second fixing hole to lock the second fixing slab and the second board.

The pivoting mechanism and the electronic device thereof in the present invention can improve the friction condition between the wire, the pivoting mechanism and the pivot body. The accommodating slot formed on the surface of the pivot body can replace the conventional design of the hollow structure. It is easier to manufacture the accommodating slot on the surface of the pivot body than to manufacture the hollow structure along an axle center of the pivot body. Lubricant can be omitted in the present invention, so as to decrease cost of the pivoting mechanism and to increase preferred assembly convenience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of the pivoting mechanism according to the embodiment of the present invention.

FIG. 2 is an assembly diagram of the pivoting mechanism according to the embodiment of the present invention.

FIG. 3 is a diagram of the electronic device according to the embodiment of the present invention.

FIG. 4 is a diagram of the first fixing portion according to the other embodiment of the present invention.

FIG. 5 is a diagram of the pivoting mechanism according to the other embodiment of the present invention.

### DETAILED DESCRIPTION

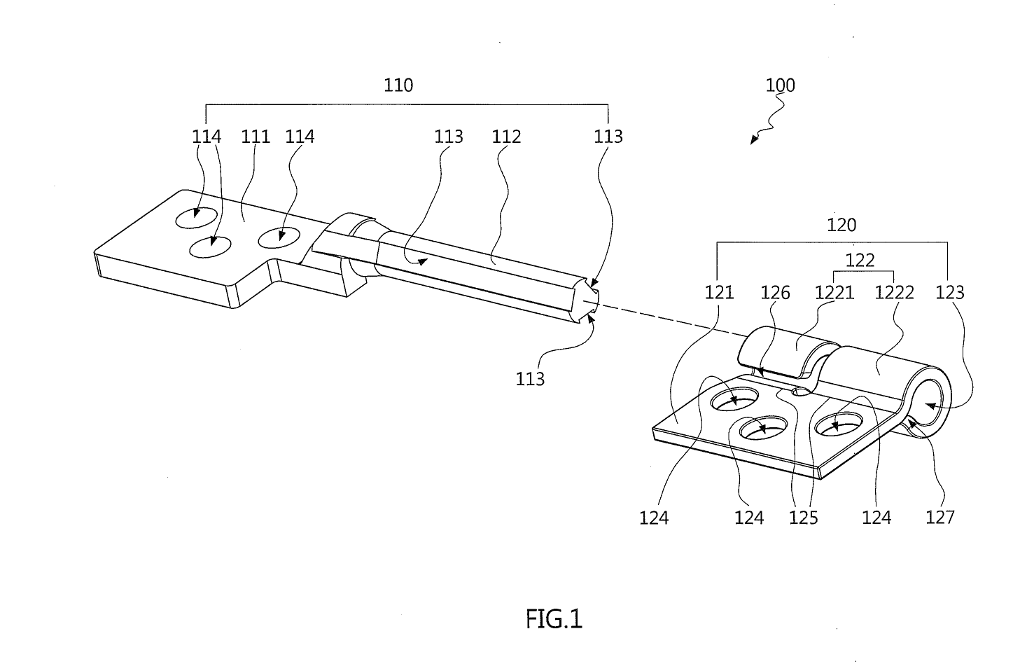

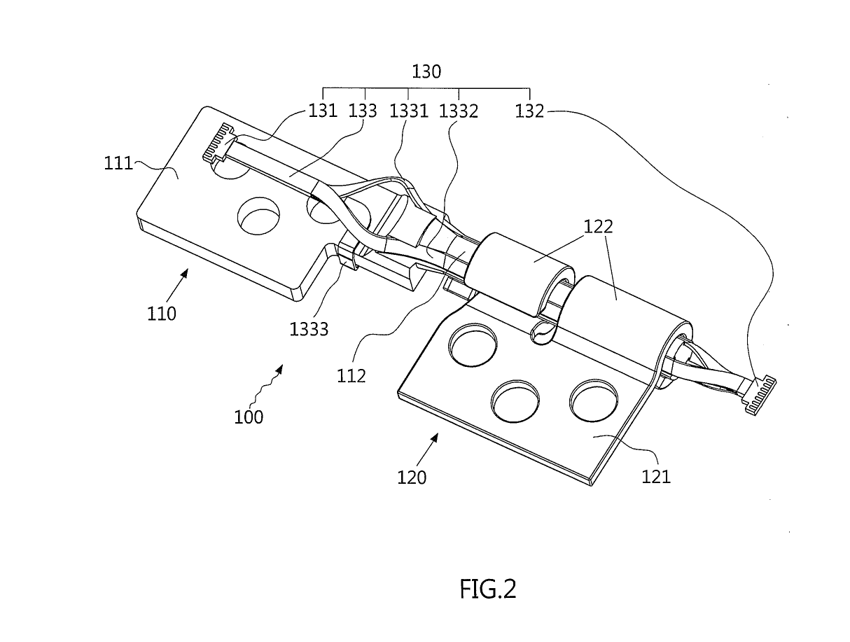

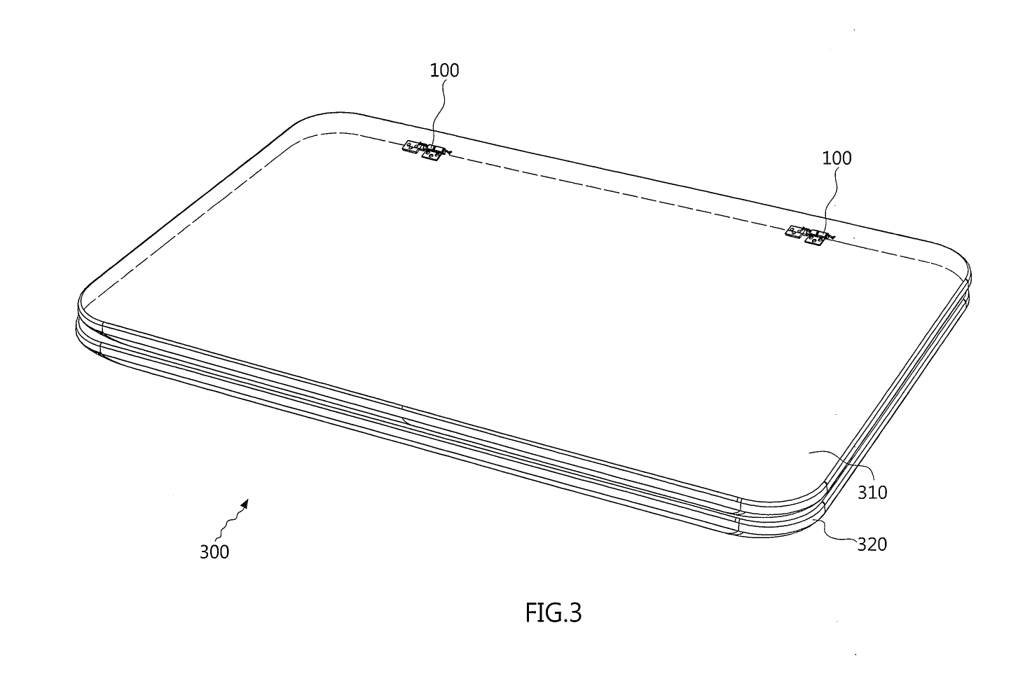

A pivoting mechanism applied to an electronic device according to pivot demand is disclosed. The electronic device can be a portable electronic device or a movable electronic device. The electronic device includes a first board and a second board pivoted to each other, such as the notebook computer, the electronic dictionary, the personal digital assistant, the game machine and so on. Please refer to FIG. 1 to FIG. 3. FIG. 1 is an exploded diagram of the pivoting mechanism according to a preferred embodiment of the present invention. FIG. 2 is an assembly diagram of the pivoting mechanism according to the preferred embodiment of the present invention. FIG. 3 is a diagram of the electronic device according to the preferred embodiment of the present invention. In this embodiment, the electronic device 300 can be the notebook computer, which includes a first board 310 and a second board 320. The first board 310 includes a first electronic unit (not shown in figures). The second board 320 includes a second electronic unit. The first electronic unit includes a panel and a backlight module. The second electronic unit includes electronic components, a battery and a keyboard. The first board 310 can pivot to the second board 320 via the pivoting mechanism 100, so that the first board 310 and the second board 320 can be folded, and the first board 310 can further be unfolded relative to the second board 320 at a predetermined angle. As shown in FIG. 2, the pivoting mechanism 100 includes a cable 130. The cable 130 includes a wire 133. An end of the wire 133 is connected to a first connector 131, and the other end of the wire 133 is connected to a second connector 132. The first electronic unit is electrically connected to the first connector 131, the second electronic unit is electrically connected to the second connector 132, the first electronic unit and the second electronic unit can be electrically connected to each other via the cable 130.

As shown in FIG. 1, the pivoting mechanism 100 includes a first fixing portion 110 and a second fixing portion 120. The first fixing portion 110 includes a first fixing slab 111 and a pivot body 112 stretching from a side of the first fixing slab 111. A plurality of accommodating slots 113 is formed on a surface of the pivot body 112. Each accommodating slot 113 stretches from a side of the pivot body 112 to the other side of the pivot body 112. The accommodating slots 113 are substantially parallel to an axial direction of the pivot body 112. The accommodating slots 113 are arranged along the axial direction and surround the surface of the pivot body 112.

The second fixing portion 120 includes a second fixing slab 121 and an annular body 122. A fixing side 125 is disposed on an edge of the second fixing slab 121. The annular body 122 stretches from the fixing side 125. The annular body 122 includes a first annular wall 1221 and a second annular wall 1222. The first annular wall 1221 stretches from the fixing side 125 and surrounds the pivot hole 123 along a counterclockwise direction (by a right-side view toward the left side as shown in FIG. 1) to be a part of the pivot hole 123. A first opening 126 is formed between the fixing side 123 and an end of the first annular wall 1221. The second annular wall 1222 stretches from the fixing side 125 and surrounds the pivot hole 123 along a clockwise direction (opposite to the structural direction of the first annular wall 1221) to be the other part of the pivot hole 123. A second opening 127 is formed between the fixing side 123 and an end of the second annular wall 1222. It is to say, the pivot hole 123 is formed by the first annular wall 1221 and the second annular wall 1222. The pivot hole 123 corresponds to the pivot body 112, so that the pivot body 112 can pass through the pivot hole 123, and the first fixing portion 110 can pivot to the second fixing portion 120 via the combination of the pivot body 112 and the annular body 122. Meanwhile, friction can be generated when the surface of the pivoting body 112 contacts an inner surface of the annular body 122 (inner wall of the pivot hole 123), so as to keep an angle stability between the first fixing portion 110 and the second fixing portion 120.

The wire 133 is disposed inside the accommodating slot 113. In the embodiment, a depth of the accommodating slot 113 is substantially greater than a thickness (radial diameter) of the wire 133. The wire 133 is not out of the surface of the pivot body 112, so as to prevent the wire 133 from damage by contact between the wire 133 and the inner wall of the pivot hole 123 when the pivot body 112 is rotated inside the pivot hole 123. As shown in FIG. 2, the wire 133 further includes a plurality of sub-wires 1331, 1332 and 1333. The sub-wires 1331, 1332 and 1333 respectively pass through the corresponding accommodating slots 113. Because the wire 133 can be divided into the sub-wires 1331, 1332 and 1333, the thickness (or the radial diameter) of each sub-wire can be reduced to prevent the annular body 122 and the sub-wires 1331, 1332 and 1333 from friction. Preferably, the adhesive layer (not shown in figures) can be disposed on a bottom of the accommodating slots 113. The sub-wires 1331, 1332 and 1333 can be adhered to the bottom of the accommodating slots 113 by the adhesive layer. The different jointing components, such as the wedging unit, can be utilized in the other embodiment to fix the wire inside the accommodating slot.

In addition, a plurality of fixing holes 114 can be formed on the first fixing slab 111. The first fixing hole 114 corresponds to the first fixing component (not shown in figures). A plurality of second fixing holes 124 ca be formed on the second fixing slab 121. The second fixing hole 124 corresponds to the second fixing component. The first fixing component and the second fixing component are screws, the other application depends on actual demand, and detailed description is omitted herein for simplicity. The screws pass through the first fixing hole 114 and the second fixing hole 124 to lock the first fixing slab 111 on the first board 310 and to lock the second fixing slab 121 on the second board 320. Thus, the first board 310 and the second board 320 of the electronic device 300 can pivot to each other via the pivoting mechanism 100 for pivot function and electrical connection.

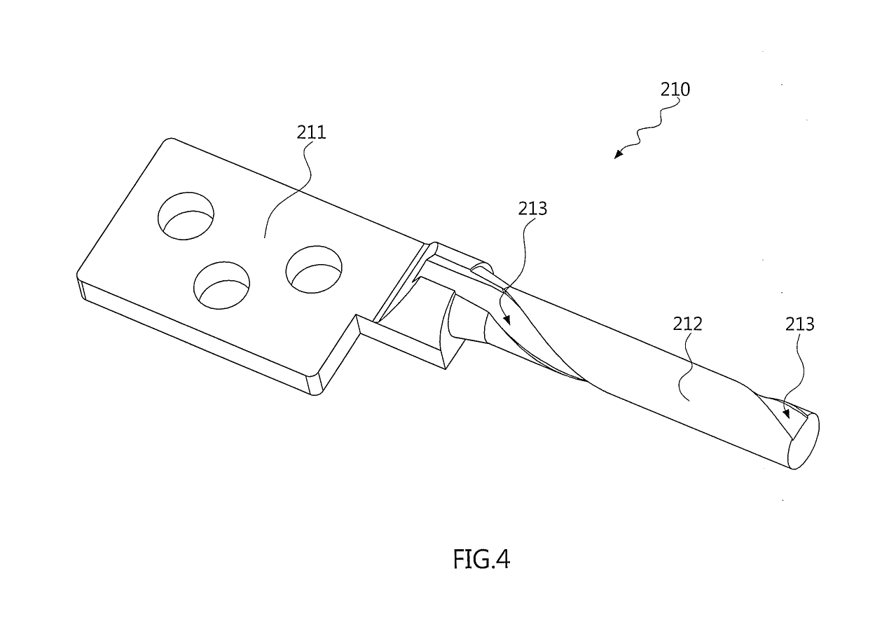

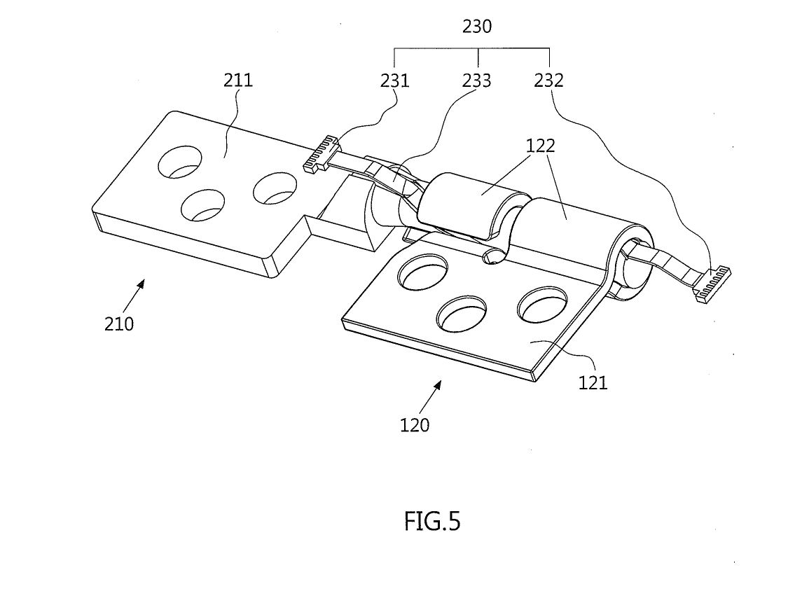

Please refer to FIG. 4 and FIG. 5. FIG. 4 is a diagram of the first fixing portion according to the other embodiment of the present invention. FIG. 5 is a diagram of the pivoting mechanism according to the other embodiment of the present invention. The last embodiment shows structural difference of the accommodating slot 213 relative to the accommodating slot 113 of the pivoting mechanism 100 shown in FIG. 1 and FIG. 2. As shown in FIG. 4, the first fixing portion 210 includes the first fixing slab 211 and the pivot body 212 stretching from a side of the first fixing slab 211. The accommodating slot 213 is formed on the pivot body 212. The accommodating slot 213 surrounds the surface of the pivot body 212 in the spiral manner. The pivot body 212 passes through the annular body 122 of the second fixing portion 120. The cable 230 includes the first connector 231, the second connector 232 and the wire 233 connected between the first connector 231 and the second connector 232. The wire 233 passes through the accommodating slot 213. In this embodiment, stable friction can be generated between the annular body 122 and the pivot body 212 when the first fixing portion 210 pivots relative to the second fixing portion 120. Due to spiral structure of the accommodating slot 213, contact area between the surface of the pivot body 212 and the inner surface of the annular body 122 is not varied by an effect of the opening (such as the first opening 126 and the second opening 127 shown in FIG. 1) of the annular body 122, no matter what angle is adjusted. The contact area between the pivot body 212 and the annular body 122 are stable during rotation, so that the friction and the torque are constant when the first fixing portion 210 rotates relative to the second fixing portion 120.

In conclusion, the pivoting mechanism and the electronic device thereof in the present invention can improve the friction condition between the wire, the pivoting mechanism and the pivot body. The accommodating slot formed on the surface of the pivot body can replace the conventional design of the hollow structure. It is easier to manufacture the accommodating slot on the surface of the pivot body than to manufacture the hollow structure along an axle center of the pivot body. Lubricant can be omitted in the present invention, so as to decrease cost of the pivoting mechanism and to increase preferred assembly convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pivoting mechanism capable of being passed through by a wire, the pivoting mechanism comprising:
a first fixing portion, the first fixing portion comprising a pivot body, an accommodating slot being formed on a surface of the pivot body, the accommodating slot stretching from a side of the pivot body to the other side of the pivot body; and
a second fixing portion, the second fixing portion comprising an annular body corresponding to the pivot body, a pivot hole being formed around the annular body;
wherein the pivot body passes through the pivot hole, the first fixing portion pivots to the second pivoting portion via a combination of the pivot body and the annular body, and the wire passes through the accommodating slot.

2. The pivoting mechanism of claim 1, wherein a plurality of accommodating slots is formed on the surface of the pivot body, the accommodating slots are arranged along an axial direction of the pivot body, the wire comprises a plurality of sub-wires, the sub-wires are respectively disposed inside the corresponding accommodating slots.

3. The pivoting mechanism of claim 1, wherein the accommodating slot is substantially parallel to an axial direction of the pivot body.

4. The pivoting mechanism of claim 1, wherein the accommodating slot surrounds the surface of the pivot body in a spiral manner.

5. The pivoting mechanism of claim 1, wherein a depth of the accommodating slot is substantially greater than a thickness of the wire.

6. The pivoting mechanism of claim 1, wherein the pivoting mechanism further comprises a jointing component corresponding to the wire, the wire is fixed inside the accommodating slot by the jointing component.

7. The pivoting mechanism of claim 6, wherein the jointing component comprises an adhesive layer disposed on a bottom of the accommodating slot, the wire is adhered inside the accommodating slot via the adhesive layer.

8. The pivoting mechanism of claim 1, wherein the second fixing portion further comprises a fixing side, the annular body comprises:
a first annular wall stretching from the fixing side and surrounding the pivot hole along a counterclockwise direction, a first opening being formed between the fixing side and an end of the first annular wall; and
a second annular wall stretching from the fixing side and surrounding the pivot hole along a clockwise direction, a second opening being formed between the fixing side and an end of the second annular wall.

9. An electronic device comprising:
a pivoting mechanism capable of being passed through by a wire, the pivoting mechanism comprising:
a first fixing portion, the first fixing portion comprising a pivot body, an accommodating slot being formed on a surface of the pivot body, the accommodating slot stretching from a side of the pivot body to the other side of the pivot body; and
a second fixing portion, the second fixing portion comprising an annular body corresponding to the pivot body, a pivot hole being formed around the annular body;
wherein the pivot body passes through the pivot hole, the first fixing portion pivots to the second pivoting portion via a combination of the pivot body and the annular body, and the wire passes through the accommodating slot;
a cable, the cable comprising the wire, a first connector and an second connector being respectively disposed on two ends of the cable;
a first board locked with the first fixing portion, the first board comprising a first electronic unit electrically connected to the first connector; and
a second board locked with the second fixing portion, the second board comprising a second electronic unit electrically connected to the second connector;
wherein the first board pivots to the second board, the first electronic unit is electrically connected to the second electronic unit.

10. The electronic device of claim 9, wherein the first fixing portion further comprises a first fixing slab whereon a first fixing hole is formed, the first fixing hole corresponds to a first fixing component, the second fixing portion further comprises a second fixing slab whereon a second fixing hole is formed, the second fixing hole corresponds to a second fixing component, the first fixing component passes through the first fixing hole to lock the first fixing slab and the first board, the second fixing component passes through the second fixing hole to lock the second fixing slab and the second board.

11. The electronic device of claim 9, wherein a plurality of accommodating slots is formed on the surface of the pivot body, the accommodating slots are arranged along an axial direction of the pivot body, the wire comprises a plurality of sub-wires, the sub-wires are respectively disposed inside the corresponding accommodating slots.

12. The electronic device of claim 9, wherein the accommodating slot is substantially parallel to an axial direction of the pivot body.

13. The electronic device of claim 9, wherein the accommodating slot surrounds the surface of the pivot body in a spiral manner.

14. The electronic device of claim 9, wherein a depth of the accommodating slot is substantially greater than a thickness of the wire.

15. The electronic device of claim 9, wherein the pivoting mechanism further comprises a jointing component corresponding to the wire, the wire is fixed inside the accommodating slot by the jointing component.

16. The electronic device of claim 15, wherein the jointing component comprises an adhesive layer disposed on a bottom of the accommodating slot, the wire is adhered inside the accommodating slot via the adhesive layer.

17. The electronic device of claim 9, wherein the second fixing portion further comprises a fixing side, the annular body comprises:
a first annular wall stretching from the fixing side and surrounding the pivot hole along a counterclockwise direction, a first opening being formed between the fixing side and an end of the first annular wall; and
a second annular wall stretching from the fixing side and surrounding the pivot hole along a clockwise direction, a second opening being formed between the fixing side and an end of the second annular wall.
